(19) United States
(12) Patent Application Publication
(10) Pub. No.: US 2020/0021047 A1
(43) Pub. Date: Jan. 16, 2020

(54) PRESS-FIT TERMINAL AND SUBSTRATE ASSEMBLY

(71) Applicant: Yazaki Corporation, Tokyo (JP)

(72) Inventors: Yuya Kishibata, Shizuoka (JP); Takahiro Yudate, Shizuoka (JP)

(21) Appl. No.: 16/436,503

(22) Filed: Jun. 10, 2019

(30) Foreign Application Priority Data
Jul. 13, 2018 (JP) 2018-133093

(51) Int. Cl. H01R 12/58

(52) U.S. Cl. CPC H01R 12/585

(57) ABSTRACT

A press-fit terminal and substrate assembly can obtain good electrical connectivity to through hole of a preflux substrate. The press-fit terminal includes a rod-like portion, a compliant portion formed wider than the rod-like portion and configured to be bent so that a width of an elongated slot at a middle portion in a width direction becomes reduced, and be pressed into the through hole, and a tip portion formed narrower than the compliant portion, the compliant portion is defined by a pair of opposing sides linearly extending in a longitudinal direction and includes a straight portion including a widest portion in the compliant portion, and the straight portion is formed such that a sum of a shortest distance between each of the pair of opposing sides and the elongated slot on a side of the rod-like portion becomes larger than that on a side of the tip portion.

### BACKGROUND OF THE INVENTION

### Field of the Invention

The present invention relates to a press-fit terminal to be press-fit connected to a through hole and a substrate assembly in which such fit terminal is assembled to a substrate.

### Description of the Related Art

Conventionally, a press-fit terminal to be press-fit connected to a through hole is known (e.g. see Patent Literature 1). Such press-fit terminal is press-fit connected to a through hole and used often cylindrically formed of copper film and a surface thereof is plated with tin. Insulating oxide film is formed on a tin-plated surface of the through hole, but while removing this oxide film the press-fit terminal enters the through hole and is electrically connected to the through hole.

### CITATION LIST

### Patent Literature

Patent Literature 1: Japanese Patent No. 4030129

### SUMMARY OF THE INVENTION

Here, a through hole in a preflux substrate is also known as the through hole formed in the substrate, which is not plated, but the surface of the copper film on the surface in the through hole is pre-coated with a flux in order to improve the wettability of the solder. In recent years, demand has been grown to use the above press-fit terminal for through hole in such preflux substrate.

However, the current press-fit terminal has room for improvement in terms of electrical connectivity in the application to the through hole in such preflux substrate.

Therefore, the present invention focuses on the room for improvement as described above and intends to provide press-fit terminal and substrate assembly capable of obtaining good electrical connectivity for the through hole in the preflux substrate.

In order to solve the above-mentioned subject, the press-fit terminal of the present invention is what is press-fit connected to the through hole, and includes a rod-like portion, a compliant portion provided continuously to one end of the rod-like portion and formed wider than the rod-like portion, having an elongated slot or a groove extending in a longitudinal direction at a middle portion in a width direction, and configured to be bent in the width direction so that a width of the elongated slot or the groove becomes reduced, and be press-fitted into the through hole; and a tip portion provided continuously to an opposite side to the rod-like portion in the compliant portion and formed narrower than the compliant portion, the compliant portion includes a straight portion defined by a pair of opposing sides linearly extending in the longitudinal direction in a plan view viewed from a direction orthogonal to both the width direction and the longitudinal direction and including a widest portion in the compliant portion, and the press-fitted terminal has at least one of forms in which the straight portion is formed such that a sum of shortest distances between each of the pair of opposing sides and the elongated slot or the groove on a side of the rod-like portion becomes larger than that on a side of the tip portion, and in which the rod-like portion on a side of the compliant portion is formed wider than the tip portion on the side of the compliant portion.

In addition, in order to solve the above problems, a substrate assembly of the present invention includes a substrate in which a through hole is formed, a press-fit terminal press-fit connected to the through hole, and the press-fit terminal is the one recited above.

In the press-fit terminal and substrate assembly of the present invention, when press-fitting the press-fit terminal, the tip of the straight portion enters the through hole while rubbing an inner surface of the through hole. If this through hole is that of the preflux substrate, flux on the inner surface of the through hole is removed on a side of the tip portion in the straight portion. And according to the present invention, a side on the side of the rod-like portion in the straight portion that continues to the side of the tip portion will contact with the inner surface of the through hole after the removal of the flux. Thus, according to the invention, for example, a portion in the straight portion contacting with the inner surface of the through hole after flux removal is on the side of the rod-like portion different from the side of the tip that removes flux. Because of this, the side of the rod-like portion should contact with the inner surface of the through hole after flux removal over the substantially entire surface. Also, since the side of the rod-like portion is a part of the straight portion, a wider contact area for electrical contact can be obtained than when a tip of a projection contacts or the like.

At this time, in the case that the straight portion is formed that the above-described sum of the shortest distances between each of the pair of opposing sides and the elongated slot or the groove on the side of the rod-like portion becomes larger than that on the side of the tip portion, the straight portion on the side of the rod-like portion will be pressed against the inner surface of the through hole by strong repulsive force to press-fitting compared with the side of the tip portion. Also, in the case where the rod-like portion is formed wider than the tip portion, the straight portion on the rod-like portion side is pressed against the inner surface of the through hole with strong repulsive force to press-fitting compared with the tip portion side.

Thus, according to the press-fit terminal and the substrate assembly of the present invention, the straight portion of the press-fit terminal on the side of the rod-like portion is pressed by the strong repulsive force across a wide contact area and contact with the inner surface in the through hole after flux removal. This makes good electrical connectivity obtained for the through hole of the preflux substrate.

### BRIEF DESCRIPTION OF THE DRAWINGS

FIG. 1 is a schematic view showing a substrate assembly according to a first embodiment of the present invention;

FIG. 2 is an enlarged view of the portion press-fit in the through hole in the press-fit terminal shown in FIG. 1;

FIG. 3 is a view showing an initial press-fit state of the press-fit terminal together with a cross section of the through hole;

FIG. 4 is schematic view showing a press-fit completion state of the press-fit terminal together with the cross section of the through hole;

FIG. 5 is a schematic view showing a press-fit terminal of a comparative example for the press-fit terminal shown in FIGS. 1 to 4;

FIG. 6 is an enlarged view of a portion press-fit in the through hole of the substrate in the press-fit terminal according to a second embodiment;

FIG. 7 is an enlarged view of a portion press-fit in the through hole of the substrate in the press-fit terminal according to a third embodiment; and

FIG. 8 is an enlarged view of a portion press-fit in the through hole of the substrate in the press-fit terminal according to a forth embodiment.

### DETAILED DESCRIPTION OF THE PREFERRED EMBODIMENTS

Hereinafter, an embodiment of the present invention will be described. First, a first embodiment will be described.

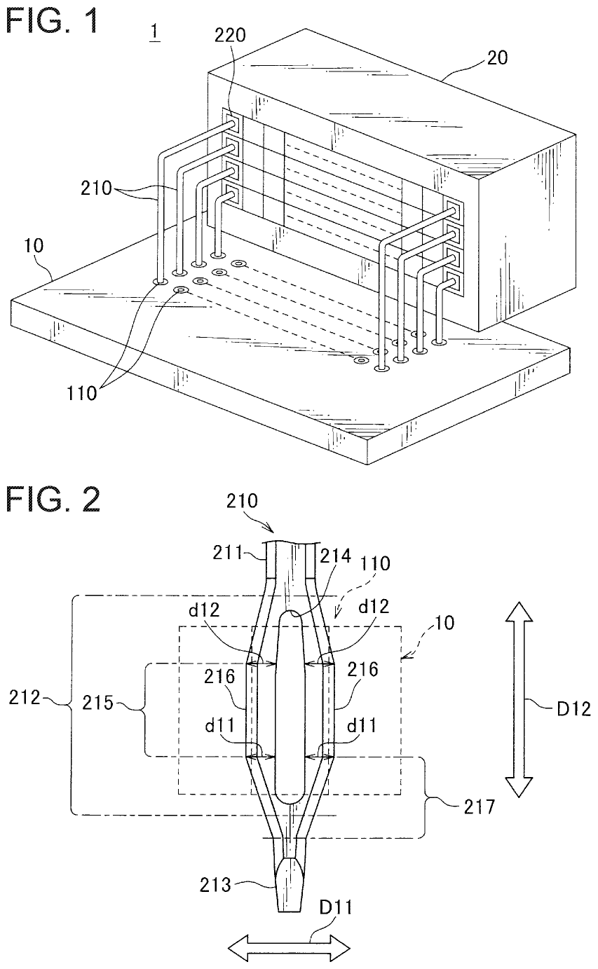

FIG. 1 is a schematic view showing a substrate assembly according to a first embodiment of the present invention.

A substrate assembly 1 shown in FIG. 1 is the one in which a connector 20 is assembled on a substrate 10 on which a circuit pattern (not shown) is formed. The substrate 10 is provided with a plurality of through hole 110, and has a plurality of terminals extending from the connector 20 attached thereto. In this embodiment, the plurality of terminals corresponds to a press-fit terminal 210 to be press-fit connected to the through hole 110. Each press-fit terminal 210 is connected to an internal terminal housed in the connector 20.

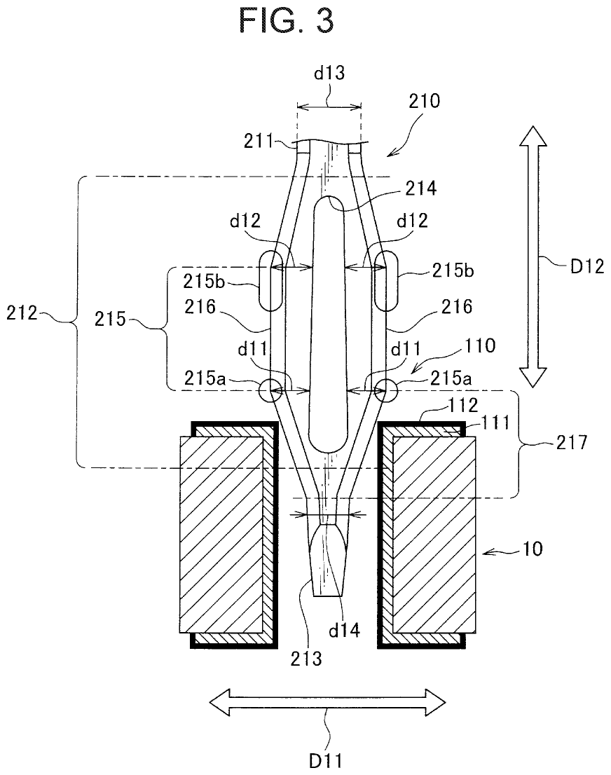

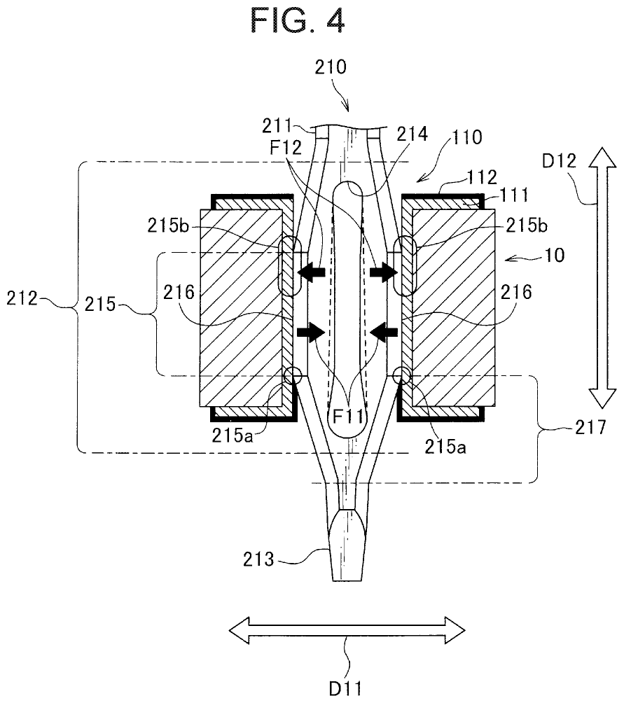

FIG. 2 is an enlarged view of the portion press-fitted in the through hole in the press-fit terminal shown in FIG. 1. FIG. 3 is a view showing an initial press-fit state of the press-fit terminal together with a cross section of the through hole, and FIG. 4 a schematic view showing a press-fit completion state of the press-fit terminal together with the cross section of the through hole.

First, in the present embodiment, the substrate 10 is a preflux substrate, and the through hole 110 is formed of copper film as shown in FIG. 3 and FIG. 4, on which preflux 112 has been previously applied.

The press-fit terminal 210 in the present embodiment is press-fit connected to the through hole 110 of such preflux substrate. The press-fit terminal 210 enters while removing the flux 112 on the inner surface of the through hole 110 at the time of press-fitting, and contacts with an exposed copper film 111, and therefore electrically connects to the through hole 110.

The press-fit terminal 210 is formed by punching a metal plate, is a substantially rectangular rod-like member in an orthogonal cross section, and is provided with a rod-like portion 211, a compliant portion 212, and a tip portion 213. Note that the press-fit terminal 210 of this embodiment is a terminal for a minute signal, and is formed by punching a metal plate having a thickness of about 0.40 mm so as to be about 0.5 mm of a width d13 of the rod-like portion 211 (FIG. 3).

One end of the rod-like portion 211 is directed to the through hole 110, and the other end is connected to an internal terminal 220 of the connector 20 shown in FIG. 1. The rod-like portion 211 is bent into an L shape at an angle of 90 degrees and extends from the internal terminal 220 to the through hole 110 of the connector 20.

The compliant portion 212 is a portion which is provided wider than the rod-like portion 211 continuously to one end of the rod-like portion 211 and in the form of a flat plate wider than the inner diameter of the through hole 11, and press-fitted into the through hole 110. At the middle portion of the compliant portion 212 in the width direction D11 is formed an elongated slot 214 extending in a length direction D12. The compliant portion 212 is bent in the width direction D11 so that the width of the elongated slot 214 is reduced in accordance with the inner diameter of the through hole 110 being press-fitted.

The tip portion 213 is a portion which is provided narrower than the compliant portion 212 continuously to the opposite side to the rod-like portion 211 in the compliant portion 212.

A straight portion 215 is provided in the compliant portion 212 as follows. The straight portion 215 is a portion which is divided by a pair of opposing sides 216 linearly extending in the length direction D12 in a plan view shown in FIGS. 2 to 4 when viewed from a direction orthogonal to both the width direction D11 and the length direction D12. And this straight portion 215 becomes a portion which includes the widest portion in the compliant portion 212.

The straight portion 215 is formed such that a sum of the shortest distances d12 between each of the pair of opposing sides 216 and the elongated slot 214 on the side of the rod-like portion 211 becomes larger than that of the shortest distances d11 on the side of the tip portion 213. In the present embodiment, the pair of opposing sides 216 extends parallel to one another, and the width of the elongated slot 214 is decreasing gradually from the side of the tip portion 213 toward the side of the rod-like portion 211. In the present embodiment, with such a configuration, the above magnitude relationship between the sum of the short distance d11 on the side of the tip portion 213 and the sum of the shortest distance d12 on the side of the rod-like portion 211 is established. And, due to such magnitude relationship, the straight portion 215 is higher in rigidity and less likely to be bent on the side of the rod-like portion 211 than on the side of the tip portion 213.

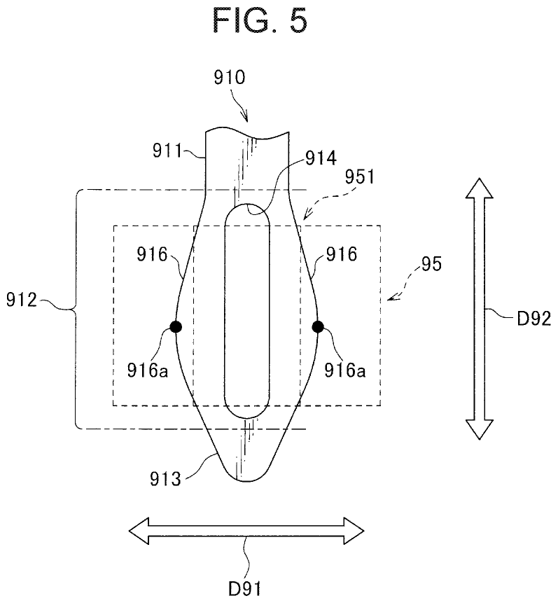

FIG. 5 is a schematic view showing a press-fit terminal of a comparative example to the press-fit terminal shown in FIGS. 1 to 4.

The press-fit terminal 910 of the comparative example shown in FIG. 5 is also press-fit connected to the through hole 951 of the substrate 95 as a preflux substrate. The press-fit terminal 910 of the comparative example also has a rod-like portion 911 connected to an internal terminal of a connector (not shown), a compliant portion 912 to be press-fitted into the thorough hole 951 of the substrate 95, and a tip portion 913 following this complaint portion 12. The compliant portion 912 is provided with an elongated slot 914 extending at a constant width in the length direction D92 at the middle portion in the width direction D91. At the time of press-fitting, the compliant portion 912 is bent in the width direction D91 so that the width of the elongated slot 914 is reduced. Further, the press-fit terminal 910 of this comparative example is formed such that the width of the compliant portion 912 on a side of the tip portion 913 and that of the compliant portion 912 on the side of the rod-like portion 911 become substantially the same.

In the press-fit terminal 910 of this comparative example, a pair of opposing sides 916 defining the compliant portion 912 is formed into a convex curve shape bulging outward in the width direction D91 in a plan view shown in FIG. 5. Therefore, the press-fit terminal 910 of the comparative example will be pressed-fitted while slide-rubbing the inner surface of the through hole 951 at an apex 916a of each side 916 of the compliant portion 912. Then, while removing the flux on the inner surface of the through hole 951 at this vertex 916a and in contact with the exposed copper film, the press-fit terminal 910 of the comparative example is electrically connected to the through hole 951.

Here, in the press-fit terminal 910 of the comparative example, the apex 916a of each side 916 of the compliant portion 912 has both the role of flux removal and the role of contacting the copper film. For this reason, a contact with the copper film is performed in the presence of unremoved flux on the front side in the pressing direction, in addition, since the contact portion is limited such as the apex 916a of the side 916, the contact area with the copper film tends to be narrow. Therefore, the press-fit terminal 910 of the comparative example has room for improvement in terms of the electrical connectivity of the substrate 95 to the through hole 951 of the substrate 95.

With respect to the press-fit terminal 910 of the comparative example described above, the press-fit terminal 210 of the first embodiment described above, at the time of press-fitting, enters the through hole 110 as follows. That is, the press-fit terminal 210 enters the through hole 110 while slide-rubbing the inner surface of the through hole 110 with the tip portion side 215a of the straight portion 215 (see FIGS. 3 and 4). This tip portion side 215a of the straight portion 215 removes the flux 112 on the inner surface of the through hole 110. And, according to the press-fit terminal 210 of the present embodiment, the rod-like portion side 215b following the tip portion side 215a in the straight portion 215 contacts with the copper film 111 exposed to the inner surface of the through hole 110 after removal of the flux.

Thus, according to the press-fit terminal 210 of the present embodiment, in the straight portion 215, the portion in contact with the exposed copper film 111 is located at a rod-like portion side 215b different from the tip side 215a that removes the flux 112. For this reason, the rod-like portion side 215b can be in contact with the copper film 111 across substantially the entire surface thereof. Moreover, the rod-like portion side 215b, since being a portion of the straight portion 215, can obtain a large contact area for electrical contact compared to the press-fit terminal 910 of the comparative example shown in FIG. 5.

At this time, in the press-fit terminal 210 of the present embodiment, the straight portion 215 is formed such that the sum of the shortest distances between each of the pair of opposing sides 216 of and the elongated slot 214 of the rod-like portion 215b becomes greater than that of the tip side 215a. Therefore, the rod-like portion side 215b of the straight portion 215 becomes difficult to bend and has high rigidity as compared with the tip portion side 215a. As a result, the rod-like portion side 215b will be press-fitted to the copper film 111 exposed on the inner surface of the through hole 110 by the strong repulsive force F12 (FIG. 4) against a compression force F11 (FIG. 4) applied to the straight portion 215 at the time of press-fitting.

According to the press-fit terminal 210 of the present embodiment, the rod-like portion side 215b is pressed by the strong repulsive force F11 and contacts with the copper film 111 across a large contact area, thereby obtaining good electrical connectivity for the through hole 110 of the substrate 10.

Further, in the present embodiment, the pair of opposing sides 216 of the straight portion 215 extends parallelly to each other, and the width of the elongated slot 214 gradually decreases from the side of the tip portion 213 toward the side of the rod-like portion 211. Thereby, the straight portion 215 is favorably formed such that the sum of the shortest distances between each side 216 and the elongated slot 214 on the side of the rod-like portion 211 becomes greater than that on the side of the tip portion 213.

Further, in the present embodiment, the width d13 of the rod-like portion 211 on the side of the compliant portion 212 is formed wider than the width d14 of the tip portion 213 on the side of the compliant portion 212.

The width d13 of the rod-like portion 211 contributes to the strength to the repulsive force F12 that is generated for press-fitting of the straight portion 215 on the rod-like portion side 215b. According to the present embodiment, because the width d13 on the side of the compliant portion 212 in the rod-like portion 211 is formed wide as described above, the repulsive force F12 to the press-fitting can increase. As a result, better electrical connectivity can be obtained with respect to the through hole 110 of the substrate 10.

Further, in the present embodiment, the elongated slots 214 in the compliant portion 212 is formed longer than the entire length of the through hole 110 of the substrate 10. According to the present embodiment, the press fit terminal 210 can be press-fitted such that the elongated slot 214 exists across the entire length of the through hole 110, as shown in FIG. 4. Thereby, the high rigid portion where the elongated slot 214 is not formed is not press-fitted, avoiding excess load that is applied to the through hole 110.

Further, in the present embodiment, a portion 217 between the straight portion 215 and the tip portion 213 in the press-fit terminal 210 is formed in a tapered shape whose width gradually decreases from the side of the straight portion 215 toward the side of the tip portion 213 in the plan view shown in FIGS. 2 to 4. And the taper shape thereof has a shape that interferes with the edge of the through hole 110, as shown in FIG. 3, when the tip portion 213 and the portion of the straight portion 214 on the side of the tip portion 213 enter the through hole 110.

According to the present embodiment, the press-fitting of the press-fit terminal 210 can be started from the state where a part of the elongated slot 214 on the side of the tip portion 213 enters the through hole 11. Therefore, at the initial stage of press-fitting, an excessive load applied to the through hole 110 by high-rigidity points where the elongated slots 214 are not formed being press-fitted can be avoided.

And, according to the substrate assembly 1 of the present embodiment, the above-described press-fit terminal 210 is press-fit connected to the through hole 110 of the substrate 10, and good electrical connectivity between the through hole 110 and the press fit terminal 210 is therefore can be obtained.

Next, a second embodiment will be described. The schematic configuration of the substrate assembly is omitted which is equivalent to that of the substrate assembly 1 of the first embodiment shown in FIG. 1.

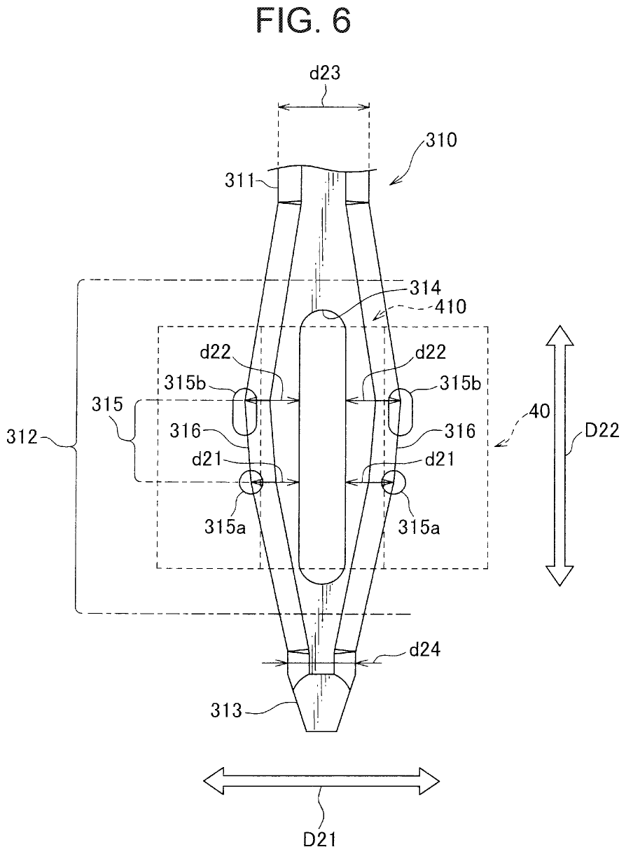

FIG. 6 shows an enlarged view of a portion press-fitted in the through hole of the substrate in the press-fit terminal according to a second embodiment.

Also a press-fit terminal 310 of the present embodiment is provided with a rod-like portion 311, a compliant portion 312 and a tip portion 313. The press-fit terminal 310 of the present embodiment is a slightly larger sized terminal corresponding to the signal system of approximately the same current as the press-fit terminal 210 of the first embodiment described above. The press-fit terminal 310 of the present embodiment is formed by punching a metal plate having a thickness of about 0.64 mm so that the width d23 of the rod-like portion 311 becomes about 0.64 mm.

Here, in the present embodiment, unlike the first embodiment, a straight portion 31 in the compliant portion 312 is formed such that a distance between the pair of opposing sides 316 gradually increases from the side of the tip portion 313 toward the side of the rod-like portion 311. And the elongated slot 314 provided extending in the longitudinal direction D22 at the middle portion of the width direction D21 of the compliant portion 312 is formed in a fixed width from the side of tip portion 313 to the side of rod-like portion 311.

In this embodiment, such a configuration of the opposing side edges 316 and the elongated slots 314 makes the straight portion 215 formed such that the sum of the shortest distances d22 on the side of the rod-like portion 311 becomes greater than that of the shortest distances d21 on the side of the tip portion 313.

Also in the present embodiment, as in the first embodiment, the width d23 of the rod-like portion 311 on the side of compliant portion 312 is formed wider than that of d24 of the tip portion 313 on the side of the compliant portion 312.

Also in the press-fit terminal 310 of the second embodiment described above, as in the first embodiment, flux on the inner surface of the through hole 410 at the tip portion side 315a of the straight portion 315 is removed. And, the rod-like portion side 315b of the straight portion 315 is press-fitted with strong repulsive force across a wide range against the copper film after flux removal. Thus, as in the first embodiment, good electrical connectivity to the through hole 410 of the substrate 40 can be obtained also in the second embodiment.

Next, a third embodiment will be described. The schematic configuration of the substrate assembly also in the third embodiment will be omitted because it is the same as that of the substrate assembly 1 of the first embodiment shown in FIG. 1.

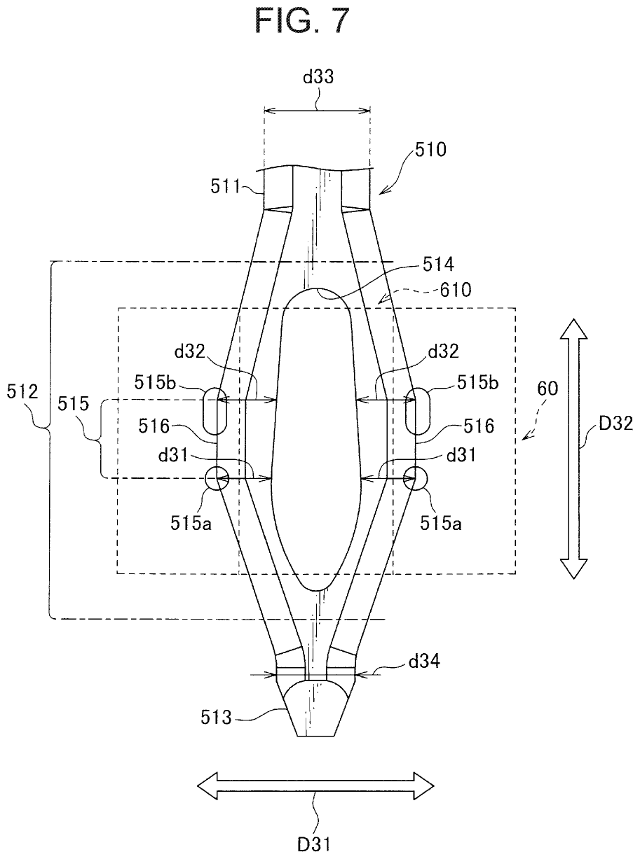

FIG. 7 is an enlarged view of a portion press-fitted in the through hole of the substrate in the press-fit terminal according to the third embodiment.

A press-fit terminal 510 of the present embodiment is also provided with a rod-like portion 511, a compliant portion 512, and a tip 513. The press-fit terminal 510 of the present embodiment is a large-sized terminal corresponding to a power supply system in which large current flows compared with the first embodiment and the second embodiment described above. The press-fit terminal 510 of the present embodiment punched and formed from a metal plate having a thickness of about 0.80 mm so as to have a width determined according to the amount of current assumed from that the width d33 of the rod-like portion 511 is within the range of about 1.2 mm to 6.3 mm.

Here, in the present embodiment, similar to the first embodiment, the straight portion 515 in the compliant portion 512 extends with a pair of opposing sides 516 in parallel with each other. And in the elongated slot 514 provided extending in the length direction D32 at the middle portion in the width direction D31 of the compliant portion 512, a width on the side of the tip 513 of a portion passing through the straight portion 515 gradually decrease toward the side of the rod-like portion 511.

In this embodiment, such a configuration of the pair of opposing sides 516 and the elongated slot 514 makes the straight portion 515 formed such that the sum of the shortest distances d32 becomes greater than that of the shortest distances d31 on the side of the tip portion 513.

Also in the present embodiment, as in the first embodiment, the width d33 in the rod-like portion 511 on the side of the compliant portion 512 is formed wider than that of d34 in the tip portion 513 on the side of the compliant portion 512.

The press-fit terminal 510 of the third embodiment described above, as similar to the first embodiment, the flux on the inner surface of the through hole 610 is removed with the tip portion side 515a of the straight portion 515. And the rod-like portion side 515b of the straight portion 515 is press-fitted with strong repulsive force against the copper film over a wide range after the flux is removed. Thus, also in the third embodiment as in the first embodiment, good electrical connectivity to the through hole 610 of the substrate 60 can be obtained.

Next, a fourth embodiment will be described. Also in the fourth embodiment, the schematic configuration of the substrate assembly will be omitted as is the same as that of the substrate assembly 1 of the first embodiment shown in FIG. 1.

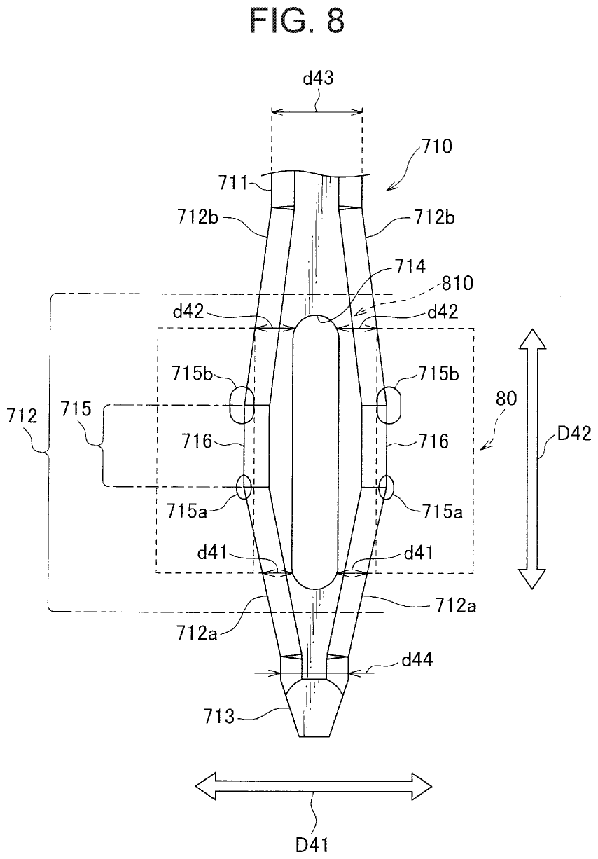

FIG. 8 is an enlarged view of a portion press-fitted in the through hole of the substrate in the press-fit terminal according to a forth embodiment.

A press-fit terminal 710 of the present embodiment is also provided with a rod-like portion 711, a compliant portion 712 and a tip portion 713. The press-fit terminal 710 of the present embodiment is a terminal corresponding to a signal system of substantially the same current as the press-fit terminal 210 of the first embodiment described above.

Here, in the present embodiment, the straight portion 715 in the compliant portion 712 extends with the pair of opposing sides 716 extending parallel to one another. The elongated slot 714 provided extending in the longitudinal direction D42 at the middle portion of the width direction D41 of the compliant portion 712 is formed in a fixed width from the tip portion 713 side to the side of the rod-like portion 711.

Further, in the present embodiment, the width d43 in the rod-like portion 711 on the side of the compliant portion 712 is formed wider than that of the d44 of the tip portion 713 on the side of the compliant portion 712. As a result, the sum of the shortest distances d42 between the side edge 712b skewing on the side of the rod-like portion 711 and the elongated slot 714 becomes greater than that of the shortest distances d41 between the side edge 712a skewing on the side of the tip portion 713 of the compliant portion 712 and the elongated slot 714. For this reason, the rod-like portion side 715b of the straight portion 715 is hard to bend and has high rigidity compared to the tip portion 715a. Thereby, also in the present embodiment, the rod-like portion side 715b is press-fitted against the inner surface of the through hole 810 by a strong repulsive force.

Also, in the press-fit terminal 710 of the fourth embodiment described above, similar to the first embodiment, flux on the inner surface of the through hole 810 is removed with the tip portion side 715a of the straight portion 715. And the rod-like portion side 715b of the straight portion 715 is pressed with strong repulsive force against the copper film over a wide range after flux removal. Thus, as in the first embodiment, good electrical connectivity to the through hole 810 of the substrate 80 can be obtained also in the fourth embodiment.

Note that the first to third embodiments described above only show representative modes of the present invention, and the present invention is not limited to these embodiments. That is, various modifications can be made without deviating from the gist of the present invention. Even with this modification, as long as the configuration of the press-fit terminal and the substrate assembly is included, it should be of course within the scope of the present invention.

For example, in the first to fourth embodiments described above, substrates 10, 40, 60, 80 as the preflux substrate is illustrated as an example of the substrate according to the present invention. However, the substrate according to the present invention is not limited to these, and a circuit pattern formed of a copper film or a tin-plated substrate or the like in which tin plating is applied to the through hole may be used. However, the fact that the remarkable effect of obtaining good electrical connectivity is described above when the press-fit terminal according to the present invention is press-fitted into the through hole of the preflux substrate.

Further, in the first to fourth embodiments described above, the compliant portions 212, 313, 512, and 712 provided with the elongated slots 214, 314, 514 and 714, respectively, as an example of the compliant portion according to the present invention are illustrated. However, the compliant portion according to the present invention is not limited to these, and it may be provided with a non-penetrating groove or the like.

In the first embodiment described above, as one example of the press-fit terminal according to the present invention, the press-fit terminal 210 is illustrated which is punched and formed from the metal plate of about 0.40 mm such that the width d13 of the rod-like portion 211 becomes about 0.5 mm. In the second embodiment described above, the press-fit terminal 310 is illustrated which is punched and formed from the metal plate of about 0.64 mm such that the width d23 of the rod-like portion 311 becomes about 0.64 mm. In addition, in the third embodiment, the press-fit terminal 510 is illustrated which is punched and formed from the metal plate of about 0.80 mm such that the width d33 of the rod-like portion 511 has a width determined according to the amount of current assumed from within the range of 1.2 mm to 6.3 mm. However, the press-fit terminals according to the present invention are not limited to these, and their specific dimensions may be set appropriately depending on conditions such as current.

Further, in the first to fourth embodiments described above, particularly in the first embodiment, as one example of the substrate assembly according to the present invention, the substrate assembly 1 in which the connector 20 is assembled to the substrate 10 is illustrated. However, the substrate assembly according to the present invention is not limited to this, and specific assembly aspect can be set arbitrarily as long as the press-fit terminal according to the present invention is press-fitted into the through hole of the substrate.

### REFERENCE SINGS LIST

1 substrate assembly
10, 40, 60, 80 substrate
20 connector
110, 410, 610, 810 through hole
111 copper film
112 flux
210, 310, 510, 710 press-fit terminal
211, 311, 511, 711 rod-like portion
212, 312, 512, 712 compliant portion
213, 313, 513, 713 tip portion
214, 314, 514, 714 elongated portion
215, 315, 515, 715 straight portion
215a, 315a, 515a, 715a tip portion side
215b, 315b, 515b, 715b rod-like portion side
216, 316, 516, 716 side
217 portion
d11, d12, d21, d22, d31, d32, d41, d42 shortest distance
d13, d14, d23, d24, d33, d34, d43, d44 width
D11, D21, D31, D41 width direction
D12, D22, D32, D42 length direction
F11 compression force
F12 repulsive force

What is claimed is:

1. A press-fit terminal to be press-fit connected to a through hole, comprising:
a rod-like portion,
a compliant portion provided continuously to one end of the rod-like portion and formed wider than the rod-like portion, having an elongated slot or a groove extending in a longitudinal direction at a middle portion in a width direction, and configured to be bent in the width direction so that a width of the elongated slot or the groove becomes reduced and be press-fitted into the through hole; and
a tip portion provided continuously to an opposite side to the rod-like portion in the compliant portion and formed narrower than the compliant portion, wherein
the compliant portion includes a straight portion defined by a pair of opposing sides linearly extending in the longitudinal direction in a plan view viewed from a direction orthogonal to both the width direction and the longitudinal direction and including a widest portion in the compliant portion, and wherein
the press-fit terminal has at least one of forms in which the straight portion is formed such that a sum of shortest distances between each of the pair of opposing sides and the elongated slot or the groove on a side of the rod-like portion becomes larger than that on a side of the tip portion, and in which the rod-like portion on a side of the compliant portion is formed wider than the tip portion on the side of the compliant portion.

2. The press-fit terminal according to claim 1, wherein
the pair of opposing sides extends parallel to one another, and
the width of the elongated slot or the groove is gradually reduced from the side of the tip portion to
the side of the rod-like portion.

3. The press-fit terminal according to claim 1, wherein
the pair of opposing sides is gradually spaced from each other from the side of the tip portion toward the side of the rod-like portion, and
the elongated slot or the groove has a constant width from the side of the tip portion toward the side of the rod-like portion.

4. A substrate assembly, comprising:
a substrate in which a through hole is formed,
a press-fit terminal press-fit connected to the through hole, wherein
the press-fit terminal is the one according to claim 1.

5. A substrate assembly, comprising:
a substrate in which a through hole is formed,
a press-fit terminal press-fit connected to the through hole, wherein
the press-fit terminal is the one according to claim 2.

6. A substrate assembly, comprising:
a substrate in which a through hole is formed,
a press-fit terminal press-fit connected to the through hole, wherein
the press-fit terminal is the one according to claim 3.

7. The substrate assembly according to claim 4, wherein
the elongated slot or the groove is formed longer than an entire length of the through hole.

8. The substrate assembly according to claim 5, wherein
the elongated slot or the groove is formed longer than an entire length of the through hole.

9. The substrate assembly according to claim 6, wherein
the elongated slot or the groove is formed longer than an entire length of the through hole.

10. The substrate assembly according to claim 4, wherein
the press-fit terminal is formed such that a portion between the straight portion and the tip portion is formed into a tapered shape whose width gradually decreases from the side of the straight portion toward the side of the tip portion in the plan view, and
the tapered shape interferes with an edge of the through hole when the tip portion and a portion of the elongated slot or the groove on the side of the tip portion enter the through hole.

11. The substrate assembly according to claim 5, wherein
the press-fit terminal is formed such that a portion between the straight portion and the tip portion is formed into a tapered shape whose width gradually decreases from the side of the straight portion toward the side of the tip portion in the plan view, and
the tapered shape interferes with an edge of the through hole when the tip portion and a portion of the elongated slot or the groove on the side of the tip portion enter the through hole.

12. The substrate assembly according to claim 6, wherein
the press-fit terminal is formed such that a portion between the straight portion and the tip portion is formed into a tapered shape whose width gradually decreases from the side of the straight portion toward the side of the tip portion in the plan view, and
the tapered shape interferes with an edge of the through hole when the tip portion and a portion of the elongated slot or the groove on the side of the tip portion enter the through hole.

13. The substrate assembly according to claim 7, wherein
the press-fit terminal is formed such that a portion between the straight portion and the tip portion is formed into a tapered shape whose width gradually decreases from the side of the straight portion toward the side of the tip portion in the plan view, and
the tapered shape interferes with an edge of the through hole when the tip portion and a portion of the elongated slot or the groove on the side of the tip portion enter the through hole.

14. The substrate assembly according to claim 8, wherein
the press-fit terminal is formed such that a portion between the straight portion and the tip portion is formed into a tapered shape whose width gradually decreases from the side of the straight portion toward the side of the tip portion in the plan view, and
the tapered shape interferes with an edge of the through hole when the tip portion and a portion of the elongated slot or the groove on the side of the tip portion enter the through hole.

15. The substrate assembly according to claim 9, wherein
the press-fit terminal is formed such that a portion between the straight portion and the tip portion is formed into a tapered shape whose width gradually decreases from the side of the straight portion toward the side of the tip portion in the plan view, and
the tapered shape interferes with an edge of the through hole when the tip portion and a portion of the elongated slot or the groove on the side of the tip portion enter the through hole.
